(19) United States
(12) Patent Application Publication
(10) Pub. No.: US 2001/0025919 A1
(43) Pub. Date: Oct. 4, 2001

(54) Method and device for producing water having absorbed wave motion energy peculiar to a color

(76) Inventor: Keiji Minamida, Toyonaka-shi (JP)

Correspondence Address: ARENT FOX KINTNER PLOTKIN & KAHN, PLLC, 1050 Connecticut Avenue, N.W., Suite 600, Washington, DC, 20036-5339, US

(21) Appl. No.: 09/778,729

(22) Filed: Feb. 8, 2001

(30) Foreign Application Priority Data
Feb. 14, 2000 (JP) 34813/2000
May 25, 2000 (JP) 153953/2000

(51) Int. Cl. G01J 3/00

(52) U.S. Cl. 250/226

(57) ABSTRACT

This invention includes a method and device for producing water having absorbed wave motion energy peculiar to a color, the method comprising the step of exposing to the sunrays a colorless transparent container containing water and a colored plate (harmless to the human body) or a colored container containing water, wherein sunrays are applied directly or using optical fibers or colored optical fibers for a certain time.

### TECHNICAL FIELD OF THE INVENTION

The present invention relates to a method for producing water which effectively affects our health and more particularly to a method for causing water to absorb wave motion energy peculiar to a color.

### DESCRIPTION OF THE PRIOR ART

It is well known that sunrays more or less have an influence on the human body, and it is also well known that our health can be improved by utilizing solar energy.

On the other hand, water is indispensable for maintaining our life and is essential for us to continue living. Consequently, attempts have been made in recent years to cause water to absorb solar energy in order to maintain our life and to promote our health by utilizing the water having absorbed solar energy.

It is known that wave motion energy differs depending on the type of color and that our body is affected by wave motion energy peculiar to a color. We are realizing that wave motion energy peculiar to a specific color affects a specific organ, among various organs, of the human body. For example, the wave motion energy of red color's own is effective to cure anemia or to prevent the drop of pressure blood.

### DISCLOSURE OF THE INVENTION

The present inventor has continuously conducted research on wave motion energy peculiar to a color. A new concept has occurred to the inventor that when water is caused to absorb wave motion energy, the wave motion energy may be effectively used with ease by utilizing the energy-absorbed water, for example, by drinking the water or by bathing in the water.

It is an object of the present invention to realize the concept, in other words, to find out a method for causing water to absorb wave motion energy peculiar to a color.

The object can be achieved by carrying out at least one of the following means.

(i) Method comprising placing water 2 into a colorless transparent container 1, immersing a colored object, e.g., a colored plate 3, into the water 2 and exposing the plate 3 to the sunrays as shown in FIG. 1, wherein a colored container may be used.

(ii) Method comprising placing water 2 into a colored container 5 for exposure to the sunrays as shown in FIG. 5, wherein the sunrays can be applied using an optical fiber(s) 6 and if necessary, a light-condenser plate 8 via a cover 7 as shown in FIG. 6, and wherein sunrays can be led through the optical fiber(s) without the light-condenser plate 8 and the optical fibers may be either colorless transparent or colored and may consist of one or two or more fibers (the plural fibers being optionally bundled into a single form, preferably using a convergent pipe 10).

(iii) Method comprising placing one or two or more colored optical fiber(s) 9 (two or more fibers being bundled with a convergent pipe) as shown in FIG. 9 into a colorless transparent container filled with water 2 as shown in FIG. 10 through a cover 7 on the container for exposure to the sunrays, wherein the cover 7 may be a simple means such as corrugated cardboard or paper board or the like having a hole.

When none of the color plate and the light-condenser plate or just the latter are used in carrying out the above method, care should be taken to bring the optical fiber(s) to exposure directly to the sunrays.

### BRIEF DESCRIPTION OF THE DRAWINGS

FIG. 1 shows a vertical section view of an example of a device capable of producing water according to the present invention.

FIG. 2 shows a vertical section view of the device wherein sunrays are reflected in water.

FIG. 3 is a view for describing the device wherein sunrays are reflected in water.

FIG. 4 is a view of the device wherein when a colored plate is immersed in water, color oscillation wave and sunrays are reflected in water.

FIG. 5 is a view for describing the device wherein when water is placed into a colored container, color oscillation wave is reflected on exposure to the sunrays.

FIG. 6 is a view for describing an embodiment wherein optical fibers and water are contained in a colored container.

FIG. 7 is a view for describing the device wherein the optical fibers, light-condenser plate and container used in FIG. 6 are assembled as an integral structure.

FIG. 8 is a view for describing an embodiment wherein when water is placed into a container with a narrow mouth for exposure to the sunrays, the sunrays entail a difficulty in passing forward and are partly reflected and absorbed.

FIG. 9 is a view for describing an embodiment wherein colored optical fibers are bundled with a convergent pipe.

FIG. 10 is a view for describing an embodiment wherein water having absorbed wave motion energy is produced using colored optical fibers bundled together with a convergent pipe and employing a colorless transparent container containing the water.

FIG. 11 is a view for describing an embodiment wherein seeds of Chinese cabbage are grown using the water having absorbed wave motion energy according to the invention and the plant is left to stand awhile.

FIG. 12 is a photocopy of a photograph showing an embodiment wherein seeds of Chinese cabbage are grown using the water having absorbed wave motion energy according to the invention and the plant is left to stand awhile.

FIG. 13 is a photocopy of a photograph showing an embodiment wherein seeds of Chinese cabbage are grown using tap water in place of the water having absorbed wave motion energy.

FIG. 14 is a photocopy of a photograph showing an embodiment wherein tap water is used in place of the water having absorbed wave motion energy.

FIG. 15 is a photocopy of a photograph of crystals given by freezing purified water.

FIG. 16 is a photocopy of a photograph of the results given by freezing purified water having absorbed solar energy alone.

FIG. 17 is a photocopy of a photograph of crystals given by freezing purified water having absorbed both solar energy and wave motion energy.

FIG. 18 is a front view for briefly describing an embodiment wherein supports are provided in a vinyl plastic greenhouse and colored and colorless optical fibers are attached to the supports.

FIG. 19 is a side view showing the same embodiment as in FIG. 18.

### BEST MODE OF CARRYING OUT THE INVENTION

Described below is a mode of carrying out this invention.

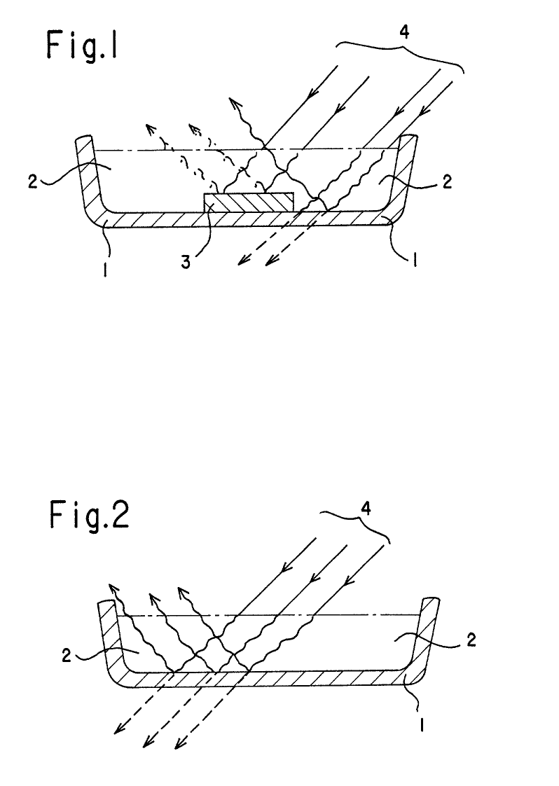

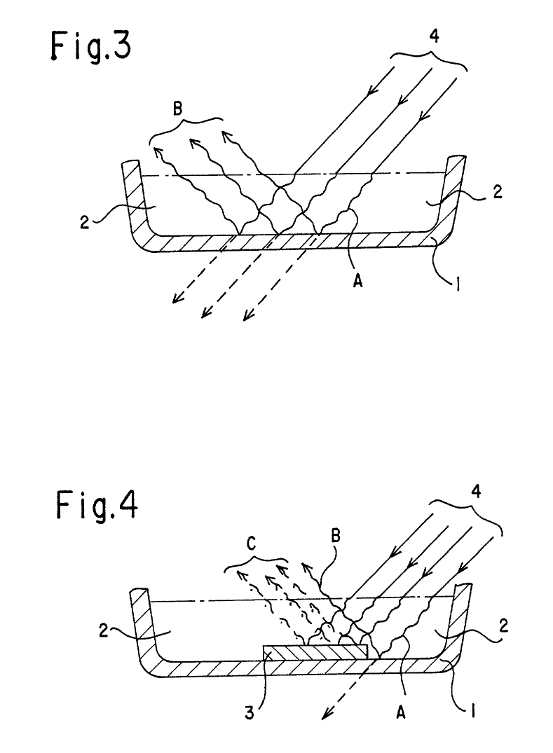

It is known that as shown in FIG. 2 depicting conventional means, when water is placed into a container, solar energy is absorbed by the water on its exposure to the sunrays for a certain period of time. In FIG. 3, sunrays 4 penetrate into water 2 and the water is caused to absorb the energy at A and B portions of sunrays. For example, it is said that tap water is allowed not only to absorb solar energy but also to scatter harmful chlorine (chloride of lime). This shows that water has a property of absorbing solar energy.

This is also very clear from the results of Example 9 to be described later. In Example 9, use was made of three kinds of water, i.e. water (purified water), water having absorbed solar energy alone, and water having absorbed color wave motion energy and solar energy according to the invention. These kinds of water were frozen to check the state of crystals and photographs of crystals were taken.

As apparent from the results of Example 9, when comparison was made between the water alone (purified water, sample 3) and the water having absorbed solar energy alone (sample 2), the sample 2 indicated a better state of crystals as shown in Table 4 and in the photographs of crystals. In other words, the water (sample 2) was found to have become better in the state of crystals by absorption of solar energy. The water having a better state of crystals is essentially improved and is good water.

According to the invention, a colored plate 3 is immersed into water 2 for exposure to the sunrays 4 as shown in FIG. 4, whereby the water 2 is caused to absorb oscillation energy in C portion of sunrays as well as in A and B portions thereof. The oscillation energy in C portion differs from the energy in B portion after reflection of sunrays 4. Namely it is the energy peculiar to the color of the colored plate. For example, when a green plate is introduced into water, oscillation energy peculiar to the green color occurs after reflection of. sunrays against the green plate. That is, the color looks green to our eyes (when a green plate is used) which means that only oscillation wave peculiar to the green color is reflected, and the other oscillation wave is absorbed. In this way, the oscillation energy peculiar to the color of the colored plate is absorbed together with solar energy by water.

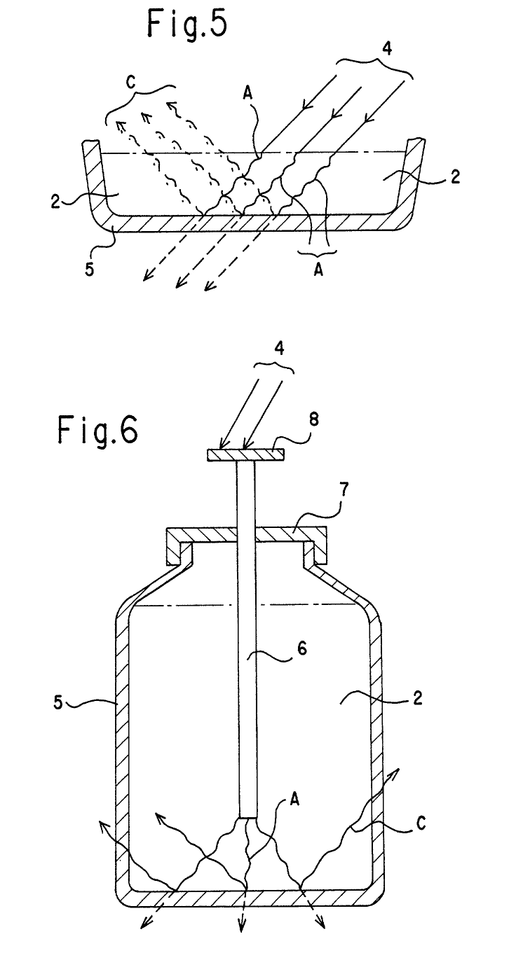

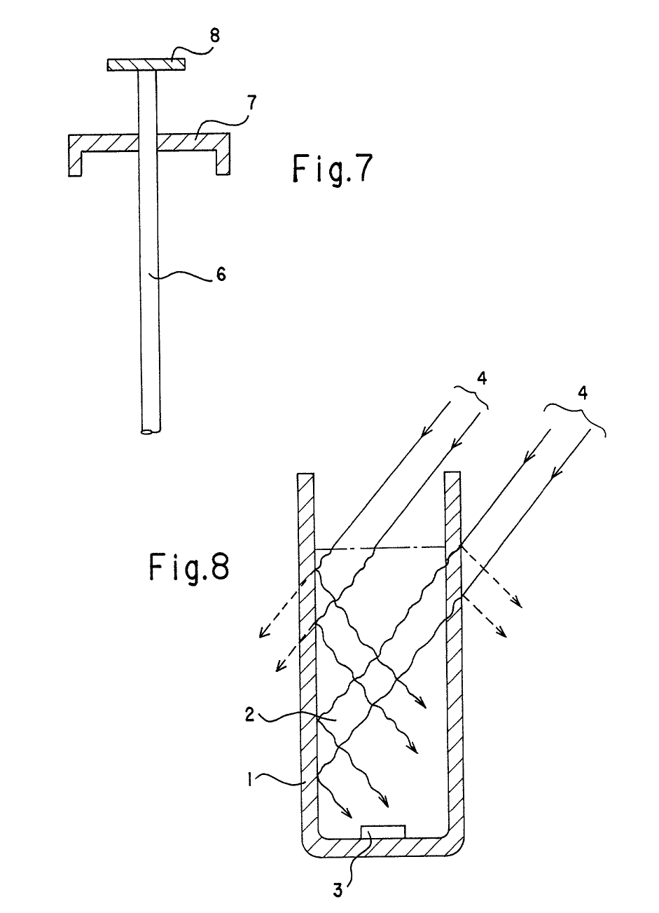

According to the present invention, when the container 5 for containing water is colored as shown in FIG. 5 and is exposed to the sunrays 4, as is the case with said colored plate, the wave motion energy peculiar to the color is absorbed by the water 2 in the colored container 5. Optionally, as shown in FIG. 6, water is placed into a colored container and a cover 7 is fitted into the container having a light-condenser plate 8 and optical fiber(s) 6 for exposure to the sunrays 4. Then sunrays are collected at the light-condenser plate 8 and strike against the water 2 through the optical fiber(s) 6, whereby the wave motion energy peculiar to the color is absorbed by the water 2 in the container 5. In this case, the cover 7 used is one fitted in the container 5 having the light-condenser plate 8 and optical fiber(s) 6 as shown in FIG. 7.

According to the invention, water is placed into a colorless transparent container 1 as shown in FIG. 10 and a colored optical fiber(s) 9 is placed into the container onto which a cover 7 of simple type is put. Sunrays are permitted to pass through the colored optical fiber(s) 9, whereby the wave motion energy peculiar to the color can be absorbed by the water 2. In this case, the container 5 may be a colored one and optical fibers may consist of a single fiber or plural fibers, preferably as bundled together with a convergent pipe 10 in the case of two or more fibers used.

In this respect, as described in Example 9, investigation was conducted as to three kinds of water, i.e. water alone (sample 3), water having absorbed solar energy alone (sample 2), and water having absorbed both color wave motion energy and solar energy (sample 1). The water having absorbed both color wave motion energy and solar energy according to the invention (sample 3) is far better than the water having absorbed solar energy alone (sample 2) as clear from the results on the state of crystals and photographs of crystals.

### Effects of the Invention

The present invention includes an embodiment wherein a colored plate is used, an embodiment wherein a colored container is used (in the latter case, a colored plate is not necessarily used in combination) and an embodiment wherein an optical fiber(s) is used. First, the embodiment using a colored plate will be described below.

According to the embodiment using a colored plate, water is placed into a container and the desired colored plate is immersed in the water. The container for use herein can be any container which can accommodate water. However, it is desirable to use a colorless transparent container, e.g. a container made of glass or resin. In this embodiment, a colored container may be used, of course.

There is no limitation on the shape of the container. It can be any shape which permits accommodation of water and a colored plate. Preferably care is taken such that the direct rays of the sun strikes against the colored plate. From this viewpoint, a container with a wide opening is preferably used. If water is contained in an opaque container of great depth, direct sunrays does not strike, or if a translucent container is used, part of the sunrays is reflected against the container or absorbed by the container, resulting in a likelihood of reducing the effect of absorption of wave motion energy. When water is introduced into a container and the container is exposed to the sunrays, the container is preferably non-detrimental to the human body. It is the most desirable to use the container as suspended.

A colored plate should be one having the desired color. There is no limitation on the size, thickness and shape of the colored plate. The colored plate should be one which can be immersed in water. When the colored plate floats, the plate is sunk with a weight. The colored plate is desirably harmless to our body. Typical examples of colored plates are plates made of porcelain and having the desired color such as a tile to which, however, plates for use herein are not limited. Useful colored plates include, for example, those of glass or resins which are harmless to our body.

According to the invention, two or more plates with different colors may be immersed in water within a container for exposure to the sunrays. Optionally a colored plate may be immersed in water within a container for exposure to the sunrays, followed by immersion of a plate with another color in water within the same container for exposure to the sunrays. A plate with an intermediate color may be used. In this case, it is desirable to avoid a combination of colors inclusive of complementary color. A plate of the same size is not necessarily used. The absorption amount of wave motion energy can be controlled by varying the size of the plate.

The most desirable means for exposure to the sunrays in the present invention is to expose the colored object to direct sunrays. The means include methods comprising directing sunrays to a container placed outside or in a room using colorless or colored optical fiber(s). In short, the means can be any in which the sunrays strikes on water.

Next, the embodiment using a colored container will be described below.

The container 5 is given the desired color, and then water 2 is placed into the colored container 5 for exposure to the sunrays. In this case, wave motion energy peculiar to the color of the colored container is absorbed as done above by the water without use of a colored plate as shown in FIG. 5. The container for use in this case, of course, preferably has a wide opening. Optionally optical fiber(s) may be used for exposure of the colored container to the sunrays 4. For example, an optical fiber (s) 6 and water 2 are accommodated into the colored container 5 as shown in FIG. 6, and the colored container 5 is closed with a cover 7. A light-condenser plate 8 is preferably provided in this case but not necessarily provided. Optionally a structure as shown in FIG. 7 may be produced wherein the optical fiber(s) 6 is integrally combined with the light-condenser plate 8 and the cover 7 is attached to the optical fiber(s). The structure can be set on the container 5 as illustrated in FIG. 6. In this case, color wave motion energy is absorbed by water.

At any rate, the shape and the type of the container 5 and the light-condenser plate 8 are not critical. The container is sufficient if it can accommodate water and can be colored. The light-condenser plate 8 is sufficient if it can collect sunrays. At any event, a suitable container and light-condenser plate are selected from a wide range.

While usually a container may be given a single color, the present invention includes a container with two or more colors.

One or two or more colored optical fibers 9 as illustrated in FIG. 10 may be used in this invention. In this case, water 2 is placed into a transparent container 1, and then one or two or more optical fibers 9 bundled with a convergent pipe 10 if necessary are put into the water 2 via the cover 7 before irradiation with sunrays. The optical fibers of the desired color are used in this case and are placed directly into the water so as to leave an upper end 11 of the fibers 9 exposed to the sunrays, or a long extension of colored optical fibers is used to place the container in a room so that the wave motion energy peculiar to the desired color is absorbed by the water. The optical fibers 9 may consist of two or more fibers of different colors, or may consist of two or more fibers of the same color. The optical fibers may be colored in its entirety or partly colored. If partly colored, the optical fibers are preferably colored at an upper end.

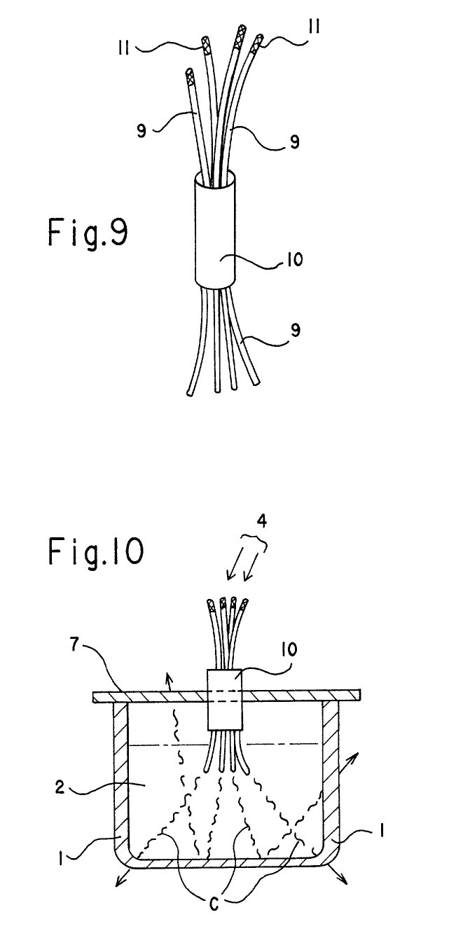

The cover 7 for use in carrying out the method of FIG. 9 may be one which can prevent inclusion of dust or trash into inside of the container and which can support the optical fibers 9 by itself or via the convergent pipe 10. Typical examples include corrugated cardboard or paper board with a hole through which the optical fibers 9 can pass. However, covers useful in the invention are not limited to them.

Water useful in the invention is not necessarily limited to ordinary water but includes a wide range of liquids. In this case, the liquids used are advantageously caused to contain solar energy and color wave motion energy. It is desirable in this case that the liquid be improved in taste and effects by absorption of solar energy and color wave motion energy.

A color therapy has been already introduced in the field of medical science. The color therapy can be conducted by applying colored light rays to the human body. However, according to the present inventor's research, it is more effective to drink the water having absorbed oscillation energy according to the present invention than the application of colored light rays. The water of the present invention can produce, of course, the desired effect by spreading the same over the human body, coating the body therewith or bathing therein.

The water of the invention is water having absorbed both solar energy (A and B portions) and color oscillation energy (wave motion energy) (C portion) as shown in FIGS. 4, 5 and 6 so that a remarkable effect is achieved thereby.

In the practice of the invention, a plate with a color required at the occasion is immersed in water and is exposed to the sunrays for a specific period of time, whereby there is obtained water which has absorbed both solar energy and color energy. The obtained water is used, e.g. by drinking, spreading, coating, bathing or the like. Further, other beverages such as beer, liquors, broth or the like may be produced using the obtained water. Further applications find use of the water for plants and fish.

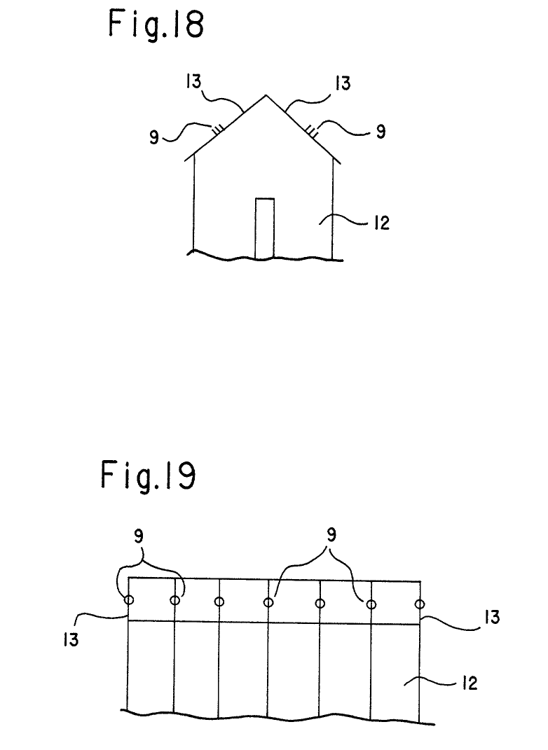

When used for plants, for example, the water having absorbed wave motion energy is sprinkled directly over a plant or seeds as mentioned in Example 7 to be described later. The drawback of conventional glass culture of entailing difficulty in shedding sunrays can be effectively overcome by introducing sunrays into a greenhouse (including vinyl plastic greenhouse) via colored optical fibers or desirably colorless optical fibers as shown in FIGS. 18 and 19. In this way, nature-like environments as well as heat insulation can be created in a greenhouse, whereby significantly good conditions for glass culture are provided.

FIGS. 18 and 19 show an embodiment wherein sunrays are introduced into a greenhouse via optical fibers and wherein colored optical fibers or desirably colorless optical fibers are fixed to supports 13 of a vinyl plastic greenhouse 12. FIG. 18 shows a front view of the embodiment and FIG. 19 shows a side view thereof. In the drawings, the vinyl plastic greenhouse is designated 12 and the supports are designated 13. It is desirable to use all of seven colors from violet color to red color for coloring optical fibers.

When used for fish, the water having absorbed wave motion energy is most often used for cultivation of fish. In this event, sunrays are introduced directly into the water in a tank, a pond or a device for cultivation of fish via colored optical fibers or desirably in combination with colorless optical fibers.

In other applications, sunrays may be introduced via colored optical fibers or desirably in combination with colorless optical fibers attached to a water tank provided in an apartment house, a building or the like.

The three embodiments described above enable the effect of absorbing both wave motion energy and solar energy.

The present invention can produce effects both in keeping daily health and in medical treatment.

(1) As to keeping health, humans have seven great energy circles which are called chakras (as described in Barbara Anne Branan, “Healing Light”, 1997, Kawadeshobo Shinsha, pp. 63-66). Seven important endocrine glands (hormones) are produced from these energy circles (chakras) as described, e.g. in “Color Life Theory”, page 132 (Jun-ichi NOMURA, 1996, Jutaku Shinposha) and “Light Ring”, Rosarin L. Briere, 1998, Taiyo Shuppan, p.p. 38 and 39. As well known, these hormones play an important role in maintaining human life. It is markedly desirable to our body that these chakras are making a normal and active behavior. Desirably chakras are activated. The following chakras, if numbered 1 to 7, correspond to colors as disclosed in Shirley McClain, “Going Within”, 1990, Chiwaki Sha, page 128 and in Barbara Anne Branan, “Healing Light”, Kawade Shobo Shinsha, 1997, page 338.

First energy circle

Red

Second energy circle

Orange

Third energy circle

Yellow

Fourth energy circle ........... Green

Fifth energy circle ............. Blue

Sixth energy circle ............. Purplish Blue

Seventh energy circle ......... Purple

To activate these chakras, it is necessary to produce and use water having absorbed color wave motion energy corresponding to the color of each chakra. The obtained water contains solar energy and is hence more desirable. It is possible to sequentially use colors changed from red to purple daily. A specific color can be used as selected for a specific chakra. Other colors than said colors, of course, can be freely used depending on the purpose.

(2) In medical treatment, it is possible to produce and use water having absorbed color wave motion energy peculiar to the color indicated according to the instructions of the doctor. If this water is used, two effects (color energy and solar energy) can be produced.

### EXAMPLES

The present invention will be described below in more detail with reference to the following examples.

### Example 1

Tap water (1000 ml) cleaned by a water cleaner was placed into a transparent glass container with a wide opening. The container was suspended at a height of about 1.5 m from the ground for exposure to direct sunrays. A tile having a surface colored blue (100 mm in length, 100 mm in width, 5 mm in thickness) was immersed in water within the container as shown in FIG. 1 and was left to stand for 8 hours in the daytime for exposure to direct sunrays.

The same procedure as above was repeated with the exception of using a plate of yellow color in place of the blue plate. Namely two types of water (having absorbed wave motion energies, respectively corresponding to blue and yellow colors) were produced using blue and yellow plates.

Ten young, healthy panelists were requested to taste the two types of water to find out the mouth feel and the like. The results are shown in Table 1.

### Comparative Examples 1 and 2

The same investigations as above were made except that only the cleaned tap water was used (Comparative Example 1) and that the cleaned tap water was exposed to direct sunrays without the color plate immersed in the cleaned tap water (Comparative Example 2). The results are shown in Table 1.

TABLE 1

| | | Mouth feel of Water | | |
|---|---|---|---|---|
| | Color of colored | | Soft- | Stimula- |
| | plate | Taste | ness | tion |
| Ex. 1 | Blue | B | A | B |
| | Yellow | B | A | B |
| Comp. | Without colored | D | D | D |
| Ex. 1 | plate (cleaned | | | |
| | water) | | | |
| Comp. | Without colored | C | B-C | C |
| Ex. 2 | plate (exposure to | | | |
| | direct sunrays) | | | |

The results were rated according to the following criteria and the ratings are an average of 10 panelists' evaluations.

[Taste]

D: Tasteless or almost tasteless

C: A little taste

B: A marked taste

[Softness]

D: Not soft or scarcely soft

C: A little soft

B: Felt soft

A: Markedly soft

[Stimulation by energy]

D: Not stimulating or scarcely stimu-lating

C: A little stimulating

B: Markedly stimulating, particularly on the tongue

### Examples 2 and Comparative Examples 3 and 4

The same procedure as in Example 1 was repeated except that commercially available mineral water was used in place of the water cleaned by the water cleaner in Example 1, and that a red plate was used in lieu of the blue plate. The results are shown in Table 2.

TABLE 2

| | | Mouth feel of Water | | |
|---|---|---|---|---|
| | Color of colored | | Soft- | Stimula- |
| | plate | Taste | ness | tion |
| Ex. 2 | Red | B | A | B |
| | Yellow | B | A | B |
| Comp. | Without colored | D | D | D |
| Ex. 3 | plate (only | | | |
| | mineral water) | | | |
| Comp. | Without colored | C | B-C | C |
| Ex. 4 | plate (exposure to | | | |
| | direct sunrays) | | | |

In the evaluation of the taste in Table 2, D means an inherent taste of mineral water, C means a little mellow taste added and B means a markedly mellow taste added. The ratings of softness and stimulation in Table 2 were the same level as in Table 1.

### Example 3

Beer of the place in summer time was produced in the conventional manner using the water produced with the red plate and obtained in Example 2. The obtained beer tasted mellow.

### Example 4

Two types of water having absorbed wave motion energies were prepared in the same manner as in Example 1 with the exception of using purple and red plates in place of the blue and yellow plates used in Example 1. The two samples were taken for comparison to find that the water produced using the red plate was mellower than when using the purple plate.

### Example 5

Water was placed into a red colored container 5 in its entirety. A device having optical fibers 6, a cover 7 and a light-condenser plate 8 integrally combined with each other as shown in FIG. 7 was set on the container 5 as shown in FIG. 7. Then, the sunrays 4 was made to shine on the light-condenser plate 8 for 6 hours in the daytime.

The obtained water was substantially the same as produced in Example 2.

### Example 6

Two kinds of water having absorbed wave motion energies were produced in the same manner as in Example 1 with the exception of using green and blue plates instead of the blue and yellow plates used in Example 1.

Each of two kinds of water obtained above was applied three times a day to the affected part of a girl (7 years old) afflicted with atopic dermatitis with the result that the condition of the skin in the affected part was recovered in about 1.5 months in the case of each water thus applied thereto. The girl had failed to recover by application of the ointment given according to the doctor's prescription.

Each water having absorbed wave motion energies, respectively was applied to the patient as described above for about a period of about 1.5 months from the beginning of October, 1999 to the middle of December, 1999.

### Example 7

The water having absorbed wave motion energy which was obtained using the yellow-colored plate in Example 1 was used for actually growing the seeds of Chinese cabbage. Stated more specifically, the soil (soil for horticulture comprising Kanuma soil as the main component) was filled into about 70% of the hollow space in an experimental pot (210 mm in width, 545 mm in length and 185 mm in depth) and seeds of Chinese cabbage were planted in the soil. Then the water having absorbed wave motion energy was applied to the soil twice a day (about 1000 cc each time) and the condition of growth was observed. Observation was made of an experiment carried out using tap water in place of the above-absorbed water in the same manner as above for comparison. The observation was continued during a period from the beginning of October, 1999 to the middle of January, 2000.

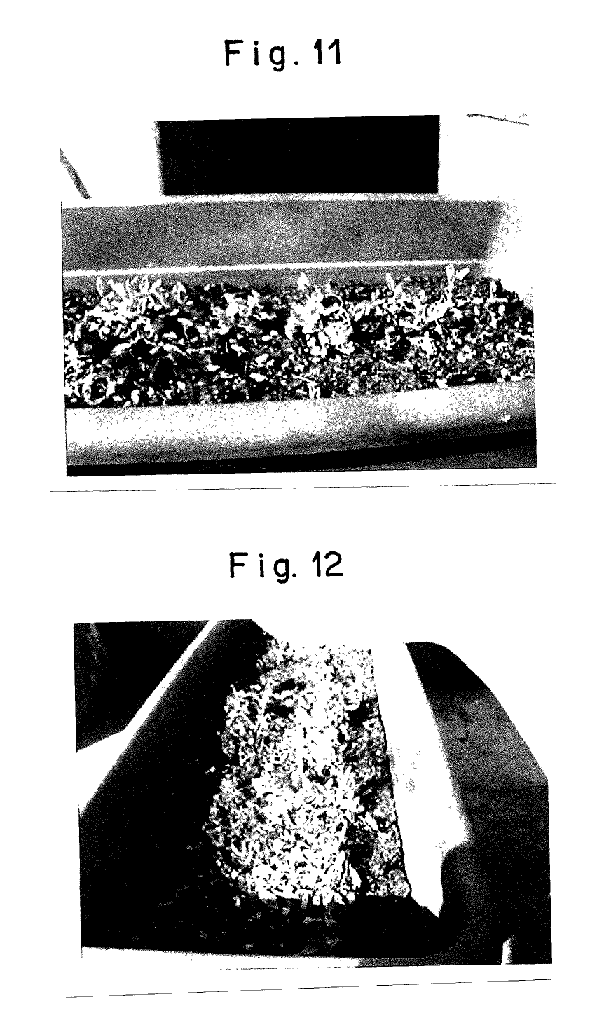

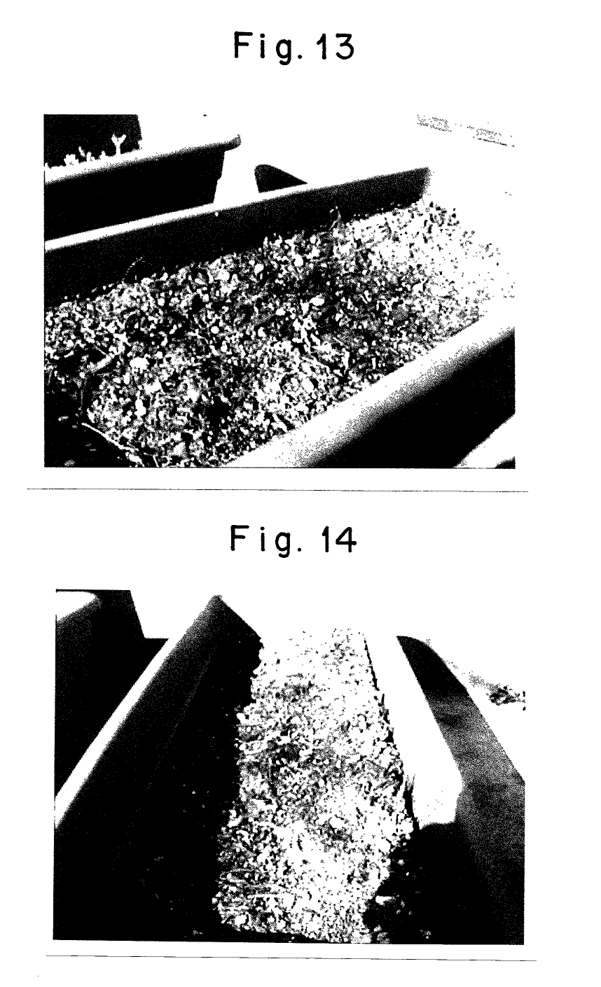

The seeds were germinated a little earlier and grown by application of water having absorbed wave motion energy than by application of tap water. After completion of growth, the plants were left to stand for a while. The plants retained their life without withering as shown in FIGS. 11 and 12 in the case of water having absorbed wave motion energy used. On the other hand, the plants completely withered and were unable to retain their life in the case of tap water used as shown in FIGS. 13 and 14.

### Example 8

Four types of water having absorbed wave motion energies were produced by the same procedure as in Example 1 except that only the color of the colored plate used in Example 1 was changed to 4 colors, i.e. orange, green, bluish purple and purple.

Using a mixture of the 4 kinds of absorption water, beer of the place was produced in the same manner as in Example 3 except that only the period of production was limited to winter. The beer (4 kinds) of the place was evaluated for the taste by 10 panelists (7 men, 3 women) with the results shown in Table 3.

TABLE 3

| Body | | Mellowness | | Flavor | |
|---|---|---|---|---|---|
| Notable | Ordinary | Notable | Ordinary | Notable | Ordinary |
| 8 | 2 | 9 | 1 | 7 | 3 |

The number in the table is the number of panelists.

The word “ordinary” used in the table means substantially the same taste as conventional beer.

### Example 9

Purified water (sample 3) was placed into a transparent glass container 1 having a wide mouth and protected with aluminum foil. Then a bundle of 30 optical fibers was passed through a hole formed in corrugated cardboard serving as a cover 7 and was fixed so that a lower end of the fibers was sufficiently immersed in the water and an upper end thereof was projected from the cover 7. The optical fibers 9 were not colored. The container was left to stand for exposure to sunrays for 8 hours to give water having absorbed solar energy (sample 2).

The same procedure as above was repeated using the same container and water as above except that use was made of colorless optical fibers and colored optical fibers (4 fibers for each kind, namely a total of 32 fibers) with each of purple, blue purple, blue, green, yellow, orange and red colors which were set in the same manner as above for exposure to the sunrays for 8 hours. The colorless optical fibers were used to produce water having absorbed both solar energy and color wave motion energy (sample 1).

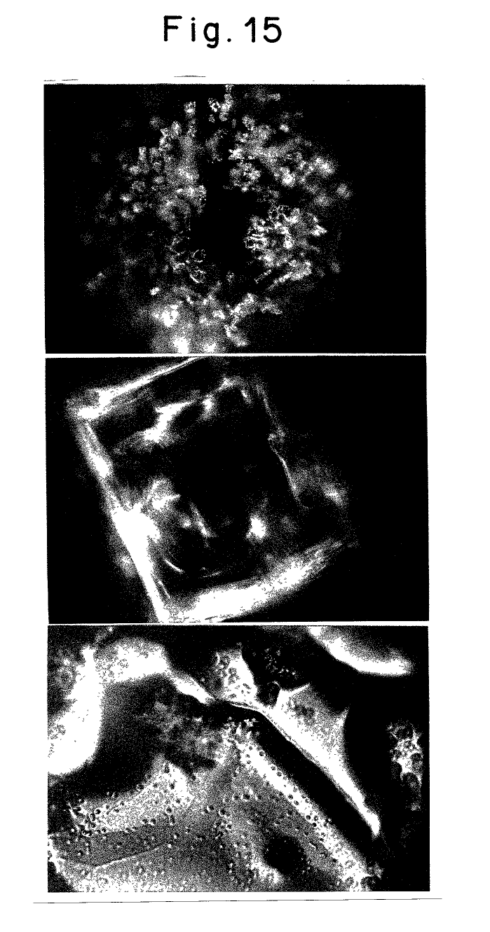

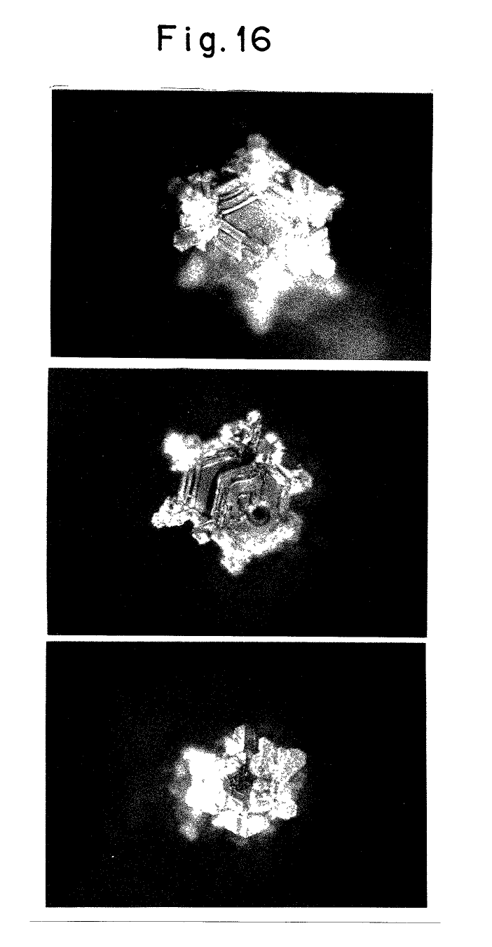

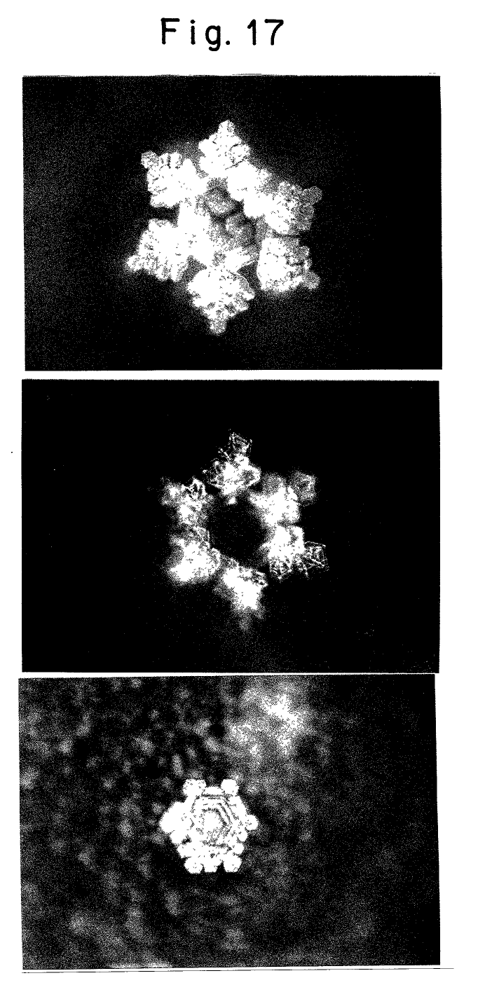

The two kinds of water thus obtained (samples 1 and 2) were frozen and investigated as to the state of crystals. The same investigation was carried out using purified water (sample 3) for comparative purpose. The investigations were conducted for these three kinds of water in the frozen state and photographs of crystals were taken. The results are shown in Table 4 and FIGS. 15 to 17. Measuring conditions in the investigations are as follows.

Freezing temperature: −20° C.±2° C. (freezing time about 4 hours);

Observation temperature: −5° C.±2° C.

Machinery used for observation: Olympus microscope (magnification: 200 X)

Number of tested samples: 50 frozen samples

TABLE 4

| Crystal | Aesthetic | Hexagonal | Lattice | Microlite |
|---|---|---|---|---|
| Sample 1 | 5 | 5 | 8 | 8 |
| Sample 2 | 5 | 6 | 8 | 1 |
| Sample 3 | 0 | 1 | 1 | 6 |

| | | | | Estimate |
|---|---|---|---|---|
| Crystal | Amorphous | Caved-in | None | point |
| Sample 1 | 10 | 5 | 9 | 38.2 p. |
| Sample 2 | 15 | 5 | 10 | 34.8 p. |
| Sample 3 | 16 | 9 | 17 | 14.4 p. |

As a result, it was revealed that there is a great difference in the state of crystals as shown in Table 4 and in crystal photographs of FIGS. 15 to 17 among three kinds of water, i.e. purified water alone (sample 3), water having absorbed solar energy alone (sample 2), and water having absorbed both color wave motion energy and solar energy (sample 1). The water having absorbed solar energy alone (sample 2) exhibited a better state of crystals than the purified water alone (sample 3), and the water having absorbed both color wave motion energy and solar energy (sample 1) shows a much better state of crystals than the purified water (sample 3). This means that the water (sample 1) is essentially improved and, of course, is enhanced in taste.

### Effects of the Invention

Water effectively useful for the human body can be economically produced by a simple procedure of causing water to absorb color wave motion energy. The obtained water can be directly used or made into other beverages. That is, the invention can achieve remarkable results.

The water produced according to the invention can activate energy circles from the viewpoint of health as described above, and can be applied to cure diseases using wave motion energy of the desired color according to the doctor's instructions for treating diseases from the viewpoint of medical treatment. Additionally the effect of solar energy can be utilized for a therapy.

1. A method for producing water having absorbed wave motion energy peculiar to a color, the method comprising the step of exposing an object having a color to sunrays so as to cause water to absorb wave motion energy peculiar to the color.

2. The method according to claim 1, wherein the colored object is immersed in water for exposure to the sunrays.

3. The method according to claim 2, wherein the colored object is a colored plate.

4. The method according to claim 1, wherein the colored object is a colored container for containing water and wherein water is placed into the colored container for exposure, directly or via optical fiber(s), to the sunrays.

5. The method according to claim 1, wherein sunrays are introduced into water via a colored optical fiber(s)o as to cause water to absorb wave motion energy peculiar to the color.

6. A device for producing water having absorbed wave motion energy peculiar to a color, the device comprising a container for containing water, a cover for the container, optical fiber(s), and optionally a light-condenser plate and a convergent pipe.

7. The device according to claim 6 which comprises a colorless transparent container for containing water, a cover for the container, a convergent pipe and colored optical fiber(s).
